(19) United States
(12) Patent Application Publication
(10) Pub. No.: US 2017/0186063 A1
(43) Pub. Date: Jun. 29, 2017

(54) SYSTEM AND METHOD FOR BARTER SUPPORT

(71) Applicant: OPTiM Corporation, Saga (JP)

(72) Inventor: Shunji SUGAYA, Tokyo (JP)

(21) Appl. No.: 15/138,344

(22) Filed: Apr. 26, 2016

(30) Foreign Application Priority Data
Dec. 23, 2015 (JP) 2015-250769

(51) Int. Cl. G06Q 30/06

(52) U.S. Cl. CPC G06Q 30/0619; G06Q 30/0629

(57) ABSTRACT

The invention is to provide a system capable of engaging in barter under which the market prices are approximately equivalent. The barter support system includes: a database that registers a plurality of articles and a plurality of market prices; a market price calculation unit that calculates the market price of a registered article; a retrieval unit that retrieves an article from the database based on the market price of the registered article; a display unit that associates and displays the registered article with a retrieved article; an article selection unit that receives selection of a retrieved article desired to be exchanged for the registered article from the registrant; and an exchange notification unit that notifies an exchange request to the owner of the retrieved article selected by the registrant.

### CROSS REFERENCE TO RELATED APPLICATIONS

This application claims priority to Japanese Patent Application No. 2015-250769 filed on Dec. 23, 2015, the entire contents of which are incorporated by reference herein.

### TECHNICAL FIELD

The present invention relates to a computer system, particularly a technology to support article exchange.

### BACKGROUND ART

Conventionally, information processors that mediate barter transaction through the Internet are known. Patent Document 1 discloses the following information processor. The server associates and stores article identification information on an article, user identification information on a user who owns the article, and status information indicating whether or not the article can be exchanged; receives a barter request from a user terminal; queries the user terminal of the user who owns an article to be exchanged in response to receiving the batter request; and receives information on acceptance of the exchange from the user terminal. The server sets the stored user identification information corresponding to the article to be exchanged for barter to user identification information on the user after the exchange in response to receiving the information on acceptance of the exchange and then sets stored status information on the article after the exchange to exchangeable.

### CITATION LIST

### Patent Literature

Patent Document 1: JP 2015-118673 A

### SUMMARY OF INVENTION

In conventional barter support systems, the market prices may be not equivalent under barter because a registrant who registers an article judges an article desired to be exchanged.

An objective of the present invention relates to provide a system capable of automatically calculating the market price of an article to be bartered and associating and displaying the article with the market price to engage in barter under which the market prices are approximately equivalent.

A system for barter support according to one embodiment of the present invention includes:

a database that registers a plurality of articles and a plurality of market prices;

a market price calculation unit that calculates the market price of a registered article, the registered article being registered for barter;

a retrieval unit that retrieves an article from the database based on the market price of the registered article, the market price being calculated by the market price calculation unit;

a display unit that associates and displays the registered article with a retrieved article, the retrieved article being retrieved by the retrieval unit;

an article selection unit that receives selection of a retrieved article desired to be exchanged for the registered article from the registrant of the registered article; and

an exchange notification unit that notifies an exchange request for the registered article to the owner of the retrieved article, the retrieved article being selected by the article selection unit.

According to the system for barter support, a registrant can retrieve an article desired to be exchanged for the registered article based on the market price of the registered article. Moreover, according to the system for barter support, a registrant can notify an exchange request for the registered article to the owner of a retrieved article desired to be exchanged for the registered article.

The display unit may associate and display the market price of the registered article with the market price of the retrieved article.

The database registers the category of each article. The system for barter support may further include a display selection unit that receives selection of the category of a selected article to be displayed on the display unit.

The market price calculation unit may calculate the market price of the registered article based on price information collected from WEB content.

The retrieval unit may retrieve an article in which the difference from the market price of the registered article is a predetermined threshold or less from the database.

The system for barter support may further include a supplement unit that supplements the difference with money or a point if the difference between the market prices of the retrieved article required for exchange and the registered article is a predetermined threshold or more.

The present invention can automatically calculate the market price of an article to be bartered and associate and display the article with the market price to engage in barter under which the market prices are approximately equivalent.

### BRIEF DESCRIPTION OF DRAWINGS

FIG. 1 shows a schematic diagram of the whole environment including the system for barter support.

FIG. 2 shows one example of the configuration of the system for barter support.

FIG. 3 shows one example of the database configuration.

FIG. 4 shows one example of the GUI that the display unit of the system for barter support generates.

FIG. 5 shows a flowchart illustrating one example of the processes in the system for barter support.

### DESCRIPTION OF EMBODIMENTS

Embodiments of the present invention will be described below with reference to the attached drawings. However, this is illustrative only, and the technological scope of the present invention is not limited thereto.

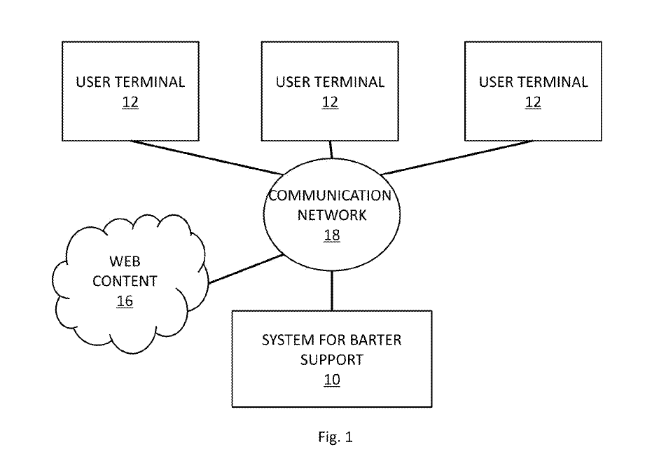

FIG. 1 shows a schematic diagram of the whole environment including the system for barter support 10 according to this embodiment.

The system for barter support 10 is a computer system to support the exchange of articles among users of this system. The system for barter support 10 and a plurality of user terminals 12 are communicatively and interactively communicated through a communication network 18 such as the Internet.

Moreover, the system for barter support 10 is accessible to various WEB contents 16 through the communication network 18.

The user terminal 12 is of a user of the system for barter support 10. Examples of the user terminal 12 include a PC, a mobile phone, a smart phone, and a tablet terminal.

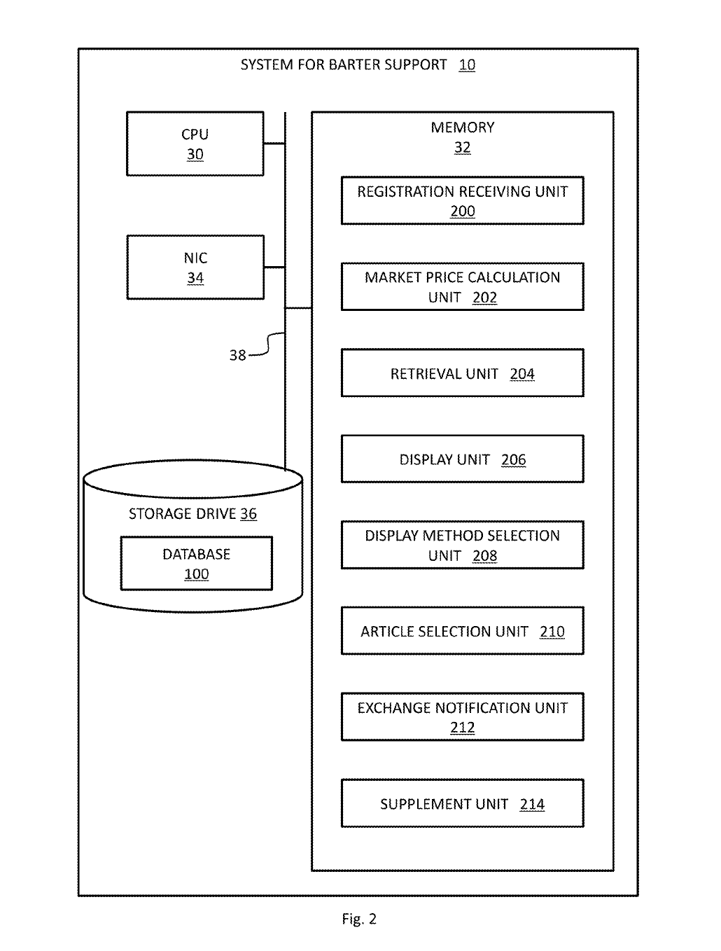

FIG. 2 shows one example of the configuration of the system for barter support 10.

The system for barter support 10 may include a central processing unit (hereinafter referred to as “CPU”) 30, a memory 32, a network interface card (hereinafter referred to as “NIC”) 34, and a storage drive 36 as the physical devices. These components may be connected through an internal bus 38.

The memory 32 is a device with data storage. The memory 32 may store a program, data, etc. to achieve the functions of the system for barter support 10. An example of the memory 32 includes a dynamic random access memory (hereinafter referred to as “DRAM”).

The CPU 30 is a device with a capability of logical operation. The CPU 30 may achieve the functions of the system for barter support 10 by executing programs read out from the memory 32.

The NIC 34 is an I/F device to connect the system for barter support 10 with the network 18. An example of the NIC 34 includes an Ethernet® card.

The storage drive 36 has a large amount of data storage. Examples of the storage drive 36 include a hard disk drive (hereinafter referred to as “HDD”) and a solid state drive (hereinafter referred to as “SSD”).

The system for barter support 10 may have a database 100 as information. The database 100 may be stored in the storage drive 36 or the memory 32, or the both. The database 100 will be described below.

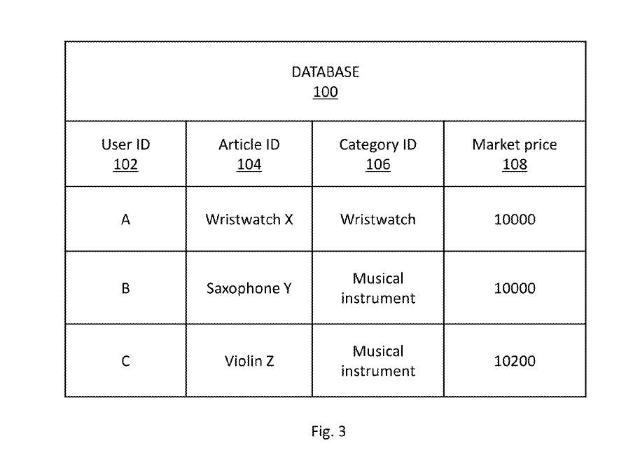

FIG. 3 shows one example configuration of the database 100.

The database 100 manages articles that users register for barter. The database 100 may have a user ID 102, an article ID 104, a category ID 106, and a market price 108 as the field values.

The user ID 102 is the identifier of a user 12. The user ID 102 may be the name, the phone number, the login ID, etc., of the user 12.

The article ID 104 is the identifier of an article for barter (i.e., a registered article of the user 12 with the user ID 102) that the user 12 with the user ID 102 owns. The article ID 104 may be the article name, the article, etc.

The category ID 106 is an identifier indicating the category of the article with the article ID 104. The category ID 106 may be a category name, a genre name etc., of the article.

The market price 108 is of an article with the article ID 104 in the market. The market price 108 may be calculated based on prices collected from various WEB contents 16 over the Internet as described later.

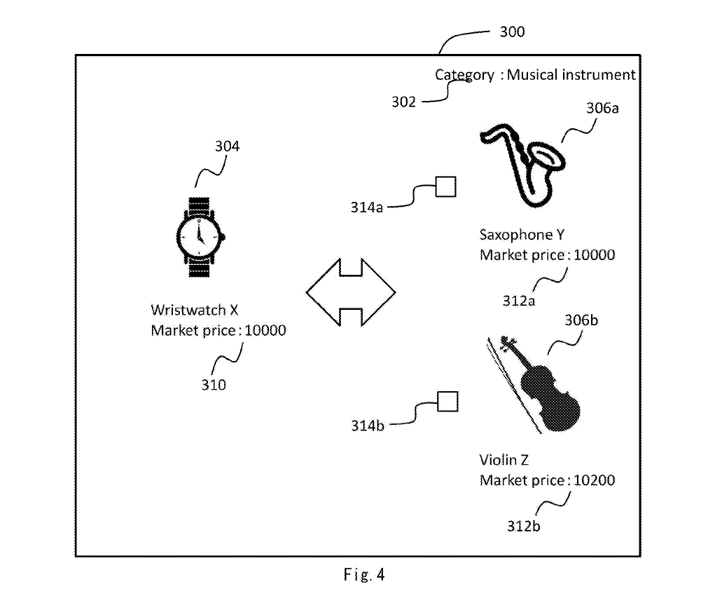

In the example of the database 100 shown in FIG. 4, the record corresponding to the user ID 102 “A” associates the registered article (104) “Wristwatch X,” the category (106) “Wristwatch,” and a market price (108) “10000” with the user ID 102 “A.” In the same way, the record corresponding to the user ID 102 “C” associates the registered article (104) “Violin Z,” the category (106) “Musical instrument,” and a market price (108) “10200” with the user ID 102 “C.”

It returns to the explanation of FIG. 2.

The system for barter support 10 may include a registration receiving unit 200, a market price calculation unit 202, a retrieval unit 204, a display unit 206, a display method selection unit 208, an article selection unit 210, an exchange notification unit 212, and a supplement unit 214 as the functions. The CPU 30 may achieve these functions by executing programs stored in the storage drive 36 or the memory 32, or the both.

The registration receiving unit 200 receives a registration request to request the registration of an article for barter from a user (registrant) terminal 12. This article required for registration is referred to as “registered article.” The registration request may include information on registrant (e.g., user name) and on a registered article (e.g., article name, category name). The registration receiving unit 200 may register information included in the registration request as one record in the database 100.

The market price calculation unit 202 calculates the market price of the registered article. The market price calculation unit 202 may collect prices from various WEB contents 16 over the Internet and calculate the market price of the registered article based on the collected price. This market price may be the average, the lowest, or the highest of the collected prices, or other values. Examples of the WEB content 16 include an EC site, a price comparison site, an auction site, an agricultural cooperative association site, and a fishery cooperative cooperation site. The market price calculation unit 202 may select a WEB content 16 corresponding to the category of the registered article and calculate the market price of the registered article.

The retrieval unit 204 retrieves an article with a market price matched with (relatively close to) the market price of the registered article calculated by the market price calculation unit 202 from the database 100. For example, the retrieval unit 204 may retrieve an article in which the difference from the market price of the registered article is a predetermined threshold or less from the database 100. This threshold may be defined previously by the system or by arbitrarily a registrant. In this embodiment, the article retrieved by the retrieval unit 204 is sometimes referred to as “retrieved article.”

The display unit 206 may associate and display a registered article with a retrieved article. The display unit 206 may associate and display the market price of the registered article with the market price of the retrieved article as shown in the example of FIG. 4. The display unit 206 may arrange and display a plurality of retrieved articles for each category or only retrieved article belonging to the category that a registrant specifies.

The display method selection unit 208 receives selection of a display method for retrieved articles on the display unit 206. Examples of the selectable display method include displaying retrieved articles for each category, sorted by name, and in descending or (ascending) order of market price.

The article selection unit 210 receives selection of a retrieved article desired to be exchanged for a registered article from a registrant. The retrieved article selected by a registrant is sometimes referred to as “selected article.” The article selection unit 210 may be a GUI to select at least one from the displayed retrieved articles as shown in the example of FIG. 4.

The supplement unit 214 supplements the difference between the market prices of a registered article and a selected article. For example, if the market price of a selected article is higher than that of a registered article, the supplement unit 214 may receive money, a point, etc., from a registrant to supplement the difference.

The exchange notification unit 212 notifies an exchange request to the owner of a selected article. The registration request may include information on registrant (e.g., user name), on a registered article (e.g., article name, category name, market price), and optionally on supplement (e.g., money, a point for supplement).

FIG. 4 shows one example of the GUI that the display unit 206 of the system for barter support 10 generates.

The GUI 300 shown in FIG. 4 is an example in the case where a registrant barters the registered article “Wristwatch X.” The GUI 300 may be generated by a WEB server of the system for barter support 10 and displayed on the WEB browser of a user terminal 12 or may be generated and displayed by a predetermined application executed in a user terminal 12.

The GUI 300 associates and displays the market price “10000” (310) of the wristwatch X (304) as a registered article with the market price “10000” (312A) and “10200” (312B) of the saxophone Y (306A) and the market price of violin Z (306B), respectively, as a retrieved articles to be exchanged for the wristwatch X (304).

The GUI 300 also arranges and displays a plurality of retrieved articles for the category “Musical instrument” (302).

The GUI 300 also displays check boxes (314A, 314B) to select an article for which a registrant desires to make an exchange from a plurality of retrieved articles.

If desiring to exchange her or his wristwatch X with other person's violin Z, a registrant only has to select the check box (314B) of the violin Z. If this check box is selected, a GUI (not shown in the attached drawings) to supplement the difference “200” between the market price “10000” of the wristwatch X and the market price “10200” of the violin Z with cash, a point, etc. may be displayed.

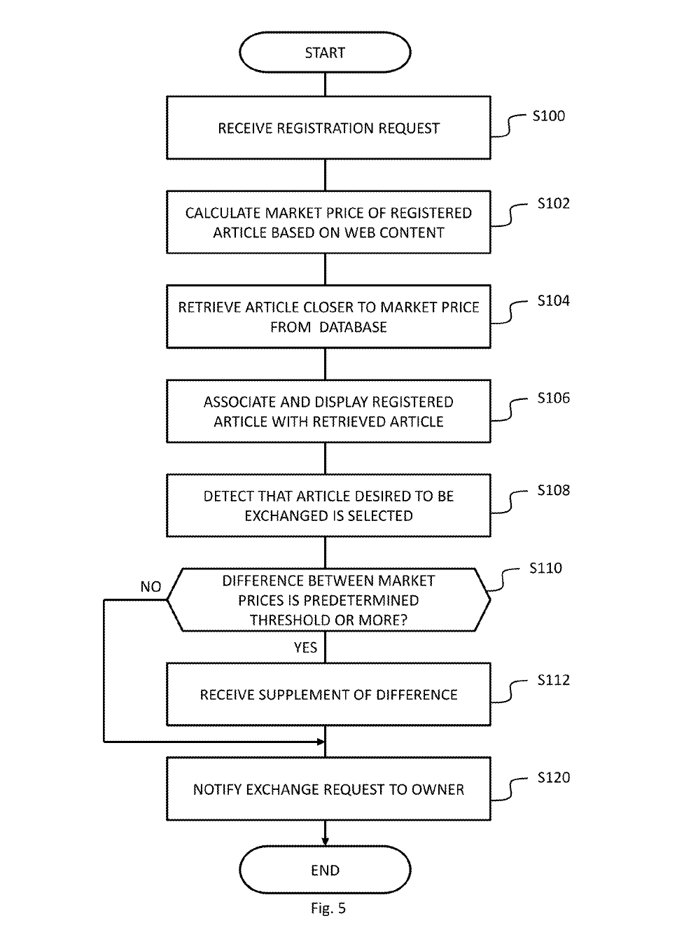

FIG. 5 shows a flowchart illustrating one example of the processes in the system for barter support 10.

### S100

The registration receiving unit 200 receives a registration request to request the registration of an article for barter (registered article) from a user (registrant) terminal 12 and proceeds to S102.

### S102

The market price calculation unit 202 calculates the market price of the article required for registration (registered article) based on WEB content 16, etc. The registration receiving unit 200 may associates and registers various types of information included in the registration request received in S100 with the price information calculated in S102 in the database 100.

### S104

The retrieval unit 204 retrieves an article in which the difference from the market price of the registered article is a predetermined threshold or less from the database 100.

### S106

The display unit 206 displays a GUI that associates and displays the market price of the registered article with the market price of a retrieved article on the terminal 12 of the registrant. If the registrant selects a category through the display method selection unit 208, the display unit 206 may display only a retrieved article belonging to the selected category.

### S108

If detecting that an article desired to be exchanged is selected from the retrieved articles, the article selection unit 210 proceeds to S110.

### S110

The supplement unit 214 judges whether or not the difference between the market prices of the registered article and the selected article is a predetermined threshold or more. If the judgment result is true (YES), the supplement unit 214 proceeds to S112, but if false (NO), to S120.

### S112

The supplement unit 214 receives information on supplement of the difference from the registrant and proceeds to S120.

### S120

The exchange notification unit 212 notifies an exchange request to the owner of the selected article. The exchange request may include information on the registered article and on the supplement from S112 as described above.

According to this embodiment, a registered article and a market price are associated and displayed so that a registrant can easily find other person's article whose market price is approximately equivalent to that of a registered article under barter. Furthermore, a plurality of retrieved articles are arranged and displayed for each category so that a registrant can more easily find an article desired to be exchanged. Still furthermore, a unit that supplements the difference between the market prices of a registered article and a selected article is provided so that a registrant can make an exchange with more other person's articles.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

10 System for barter support
12 User terminal
30 CPU
32 Memory
34 NIC
36 Storage drive
100 Database
200 Registration receiving unit
202 Market price calculation unit
204 Retrieval unit
206 Display unit
208 Display method selection unit
210 Article selection unit
212 Exchange notification unit
214 Supplement unit

What is claimed is:

1. A system for barter support, comprising:
a database that registers a plurality of articles and a plurality of market prices;
a market price calculation unit that calculates the market price of a registered article, the registered article being registered for barter;
a retrieval unit that retrieves an article from the database based on the market price of the registered article, the market price being calculated by the market price calculation unit;
a display unit that associates and displays the registered article with a retrieved article, the retrieved article being retrieved by the retrieval unit;
an article selection unit that receives selection of a retrieved article desired to be exchanged for the registered article from the registrant of the registered article; and
an exchange notification unit that notifies an exchange request for the registered article to the owner of the retrieved article, the retrieved article being selected by the article selection unit.

2. The system for barter support according to claim 1, wherein the display unit associates and displays the market price of the registered article with the market price of the retrieved article.

3. The system for barter support according to claim 1, further comprising a display selection unit, wherein the database registers the category of each article, and the display selection unit receives selection of the category of a selected article to be displayed on the display unit.

4. The system for barter support according to claim 1, wherein the market price calculation unit calculates the market price of the registered article based on price information collected from WEB content.

5. The system for barter support according to claim 1, wherein the retrieval unit retrieves an article in which the difference from the market price of the registered article is a predetermined threshold or less from the database.

6. The system for barter support according to claim 1, further comprising: a supplement unit that supplements the difference with money or a point if the difference between the market prices of the retrieved article required for exchange and the registered article is a predetermined threshold or more.

7. A method for barter support, comprising:
a registration step of registering market prices of a plurality of articles in a database;
a calculation step of calculating the market price of a registered article, the registered article being registered for barter;
a retrieval step of retrieving an article from the database based on the market price of the registered article, the market price being calculated in the market price calculation step;
a display step of associating and displaying a registered article with a retrieved article, the retrieved article being retrieved in the retrieval step;
an article selection step of receiving selection of a retrieved article desired to be exchanged for the registered article from the registrant of the registered article; and
an exchange notification step of notifying an exchange request for the registered article to the owner of the retrieved article selected in the article selection step.
